(19) United States
(12) Patent Application Publication
(10) Pub. No.: US 2014/0021870 A1
(43) Pub. Date: Jan. 23, 2014

(54) ORGANIC LIGHT EMITTING DISPLAY AND METHOD OF DRIVING THE SAME

(71) Applicant: SAMSUNG DISPLAY CO., LTD., Yongin-si (KR)

(72) Inventors: Sung-Bo AN, Yongin-si (KR); Chang-Wook KANG, Yongin-si (KR); Dong-Hwan LEE, Yongin-si (KR)

(73) Assignee: SAMSUNG DISPLAY CO., LTD., Yongin-si (KR)

(21) Appl. No.: 13/668,183

(22) Filed: Nov. 2, 2012

(30) Foreign Application Priority Data
Jul. 17, 2012 (KR) 10-2012-0077789

(51) Int. Cl. H05B 37/02

(52) U.S. Cl. 315/161

(57) ABSTRACT

There is provided an organic light emitting display capable of displaying an image of uniform brightness. The organic light emitting display includes a panel including pixels, the pixels including driving transistors, the gate electrodes of the driving transistors being configured to be initialized by voltages supplied from an initializing power supply, and an initializing power supply generator for supplying the initializing power supply. The initializing power supply generator is configured to set a voltage value of the initializing power supply to vary to correspond to a position of the panel.

### CROSS-REFERENCE TO RELATED APPLICATION

This application claims priority to and the benefit of Korean Patent Application No. 10-2012-0077789, filed on Jul. 17, 2012, in the Korean Intellectual Property Office, the entire content of which is incorporated herein by reference.

### BACKGROUND

1. Field

Embodiments of the present invention relate to an organic light emitting display and a method of driving the same, and more particularly, to an organic light emitting display capable of displaying an image with uniform brightness and a method of driving the same.

2. Description of the Related Art

Recently, various flat panel displays (FPDs) capable of reducing weight and volume as compared to cathode ray tubes (CRTs) have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLEDs) that generate light by re-combination of electrons and holes. The organic light emitting display has high response speed and is driven with low power consumption.

The organic light emitting display includes pixels positioned at crossing regions of data lines and scan lines, a data driver for supplying data signals to the data lines, and a scan driver for supplying scan signals to the scan lines.

The scan driver sequentially supplies the scan signals to the scan lines. The data driver supplies the data signals to the data lines in synchronization with the scan signals.

The pixels are selected when the scan signals are supplied to the scan lines to receive the data signals from the data lines. A pixel that receives a data signal charges a voltage corresponding to a voltage difference between the data signal and a first power supply in a storage capacitor. Then, the pixel supplies a current corresponding to the voltage charged in the storage capacitor from the first power supply to a second power supply via an organic light emitting diode (OLED) to generate light with set or predetermined brightness.

However, in a conventional pixel, a desired voltage may not be charged in the storage capacitor due to the voltage drop of the first power supply so that an image with desired brightness is not displayed. In more detail, in the first power supply for supplying a set or predetermined current to the OLED, a voltage drop (e.g., a predetermined voltage drop) is generated to correspond to the amount of current supplied to the OLED. In this case, a desired voltage is not charged in the storage capacitor corresponding to a voltage difference between the first power supply and the data signal.

The current that flows from the first power supply to the OLED is determined as illustrated in EQUATION 1.

I=K(ELVDD−Vdata)² [EQUATION 1]

In EQUATION 1, K, ELVDD, and Vdata represent a constant, the voltage of the first power supply, and the voltage of the data signal, respectively. As illustrated in EQUATION 1, when the voltage of the first power supply ELVDD changes, the current that flows through the pixel changes so that a uniform image may not be displayed. For example, when the voltage of the first power supply ELVDD is supplied from the upper side of a panel, the brightness of the panel is reduced from the upper side of the panel toward the lower side of the panel.

### SUMMARY

Accordingly, embodiments of the present invention have been made to provide an organic light emitting display capable of displaying an image with uniform brightness and a method of driving the same.

In one embodiment, there is provided an organic light emitting display, including a panel including pixels, the pixels including driving transistors, the gate electrodes of the driving transistors being configured to be initialized by voltages supplied from an initializing power supply, and an initializing power supply generator for supplying the initializing power supply. The initializing power supply generator is configured to set a voltage value of the initializing power supply to vary to correspond to a position of the panel.

The organic light emitting display may further include a first power supply input to one side of the panel in order to supply current to the pixels. The initializing power supply generator may be configured to generate the initializing power supply so that the voltage value of the initializing power supply is reduced from the one side of the panel toward another side of the panel. The panel may include a plurality of blocks between the one side to the another side of the panel. The initializing power supply having the same voltage value may be supplied to pixels positioned at the same block. The initializing power supply generator may include a plurality of resistors positioned between a third power supply and a fourth power supply lower in voltage than the third power supply. Voltages divided by the resistors may be set as voltage values of the initializing power supply.

Each of the pixels may include an organic light emitting diode (OLED) having a cathode electrode coupled to a second power supply, a corresponding one of the driving transistors for controlling an amount of current supplied from the first power supply to the second power supply via the OLED, and a second transistor coupled between a gate electrode of the driving transistor and the initializing power supply generator. Each of the pixels may further include a third transistor for coupling the driving transistor in a form of a diode.

In an embodiment, there is provided a method of driving an organic light emitting display including pixels in which voltages of gate electrodes of driving transistors are initialized using initializing power supplies, the method including inputting a first power supply to one side of a panel including the pixels in order to supply current to the pixels. A voltage value of the initializing power supply is set to vary between one side of the panel and another side that faces the one side.

The voltage value of the initializing power supply may be set to be reduced from the one side of the panel toward the another side of the panel. The panel may be divided into a plurality of blocks between the one side and the another side. Pixels included in the same block may receive the initializing power supplies having the same voltage value.

In the organic light emitting display according to embodiments of the present invention and the method of driving the same, the voltage of the initializing power supply is controlled to correspond to the voltage drop of the first power supply so that an image with uniform brightness may be displayed.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a view illustrating the brightness of a panel corresponding to the voltage drop of a first power supply;

FIG. 2 is a view illustrating an organic light emitting display according to an embodiment of the present invention;

FIG. 3 is a view illustrating an initializing power supply voltage supplied by an initializing power supply generator of FIG. 2;

FIG. 4 is a view illustrating the brightness of a panel corresponding to the voltage drop of the first power supply and the voltage of an initializing power supply;

FIG. 5 is a circuit diagram illustrating a pixel according to an embodiment of the present invention;

FIG. 6 is a view illustrating driving waveforms supplied to the pixel illustrated in FIG. 5;

FIG. 7 is a view illustrating an initializing power supply generator according to an embodiment of the present invention; and

FIG. 8 is a view illustrating the voltage value of an initializing power supply when the panel is divided into a plurality of blocks according to an embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or indirectly coupled to the second element via a third element. Further, some of the elements that are not essential to the complete understanding of the invention may be omitted for clarity. Also, like reference numerals refer to like elements throughout.

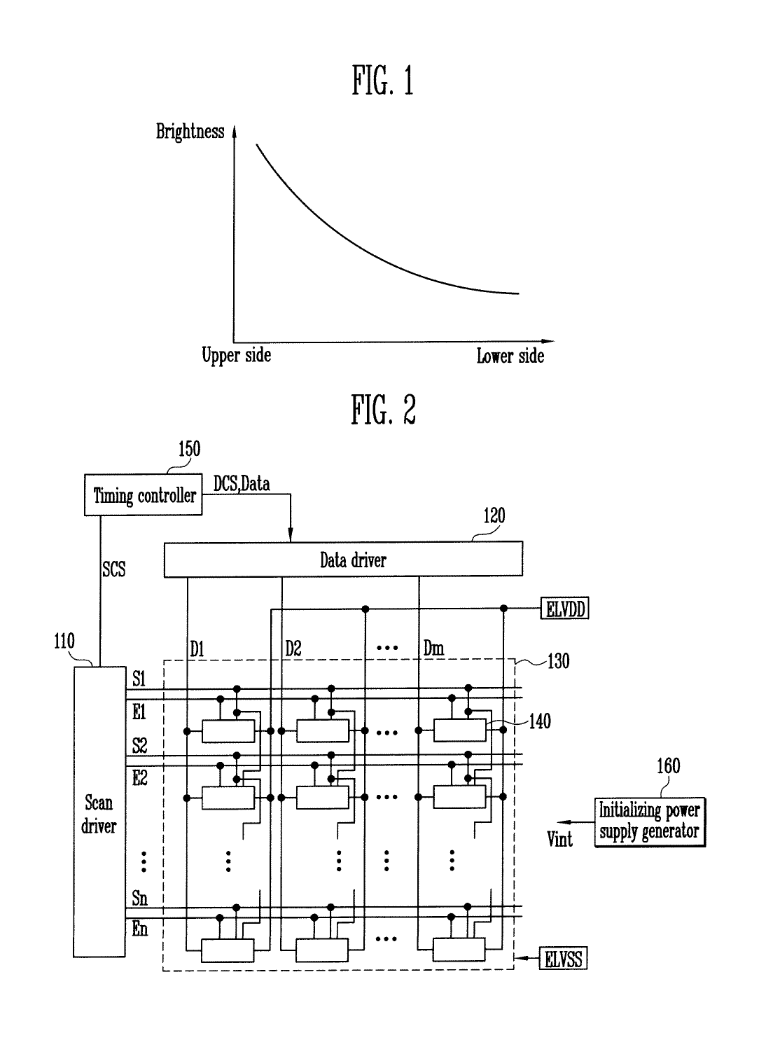

Hereinafter, an organic light emitting display and a method of driving the same will be described in detail as follows with reference to FIGS. 2 through 8 in which embodiments by which those skilled in the art may easily perform the present invention are included.

FIG. 2 is a view illustrating an organic light emitting display according to an embodiment of the present invention.

Referring to FIG. 2, the organic light emitting display according to the embodiment of the present invention includes a display unit 130 including pixels 140 positioned at the crossing regions of scan lines S1 to Sn and data lines D1 to Dm, a scan driver 110 for driving the scan lines S1 to Sn and emission control lines E1 to En, a data driver 120 for driving the data lines D1 to Dm, and a timing controller 150 for controlling the scan driver 110 and the data driver 120.

In addition, the organic light emitting display according to the embodiment of the present invention includes an initializing power supply generator 160 for generating an initializing power supply Vint having various voltage values to correspond to positions of a panel.

The timing controller 150 generates a data driving control signal DCS and a scan driving control signal SCS to correspond to synchronizing signals supplied from the outside. The data driving control signal DCS generated by the timing controller 150 is supplied to the data driver 120, and the scan driving control signal SCS generated by the timing controller 150 is supplied to the scan driver 110. The timing controller 150 supplies data Data supplied from the outside to the data driver 120.

The scan driver 110 receives the scan driving control signal SCS from the timing controller 150. The scan driver 110 that receives the scan driving control signal SCS generates scan signals and sequentially supplies the generated scan signals to the scan lines S1 to Sn. In addition, the scan driver 110 generates emission control signals in response to the scan driving control signal SCS and sequentially supplies the generated emission control signals to the emission control lines E1 to En. Here, the width (e.g., pulse width) of the emission control signals is set to be equal to or wider than the width of the scan signals. For example, the emission control signal supplied to an i-th (i is a natural number) emission control line Ei overlaps the scan signal supplied to an i-th scan line Si.

The data driver 120 receives the data driving control signal DCS from the timing controller 150. The data driver 120 that receives the data driving control signal DCS generates data signals and supplies the generated data signals to the data lines D1 to Dm in synchronization with the scan signals.

The display unit 130 receives a first power supply ELVDD and a second power supply ELVSS from the outside and supplies the first power supply ELVDD and the second power supply ELVSS to the pixels 140. Each of the pixels 140 includes a driving transistor for controlling an amount of current supplied from the first power supply ELVDD to the second power supply ELVSS via an OLED to correspond to the data signals. Before the data signal is supplied, the gate electrode of the driving transistor is initialized to the voltage of the initializing power supply Vint.

The initializing power supply generator 160 generates the initializing power supply Vint having various voltage values to correspond to the positions of the panel. For example, when the first power supply ELVDD is supplied to one side of the panel (e.g., the upper side), the initializing power supply generating unit 160 generates the initializing power supply Vint so that a voltage value is reduced from one side of the panel toward the other side (e.g., the lower side) that faces the one side as illustrated in FIG. 3.

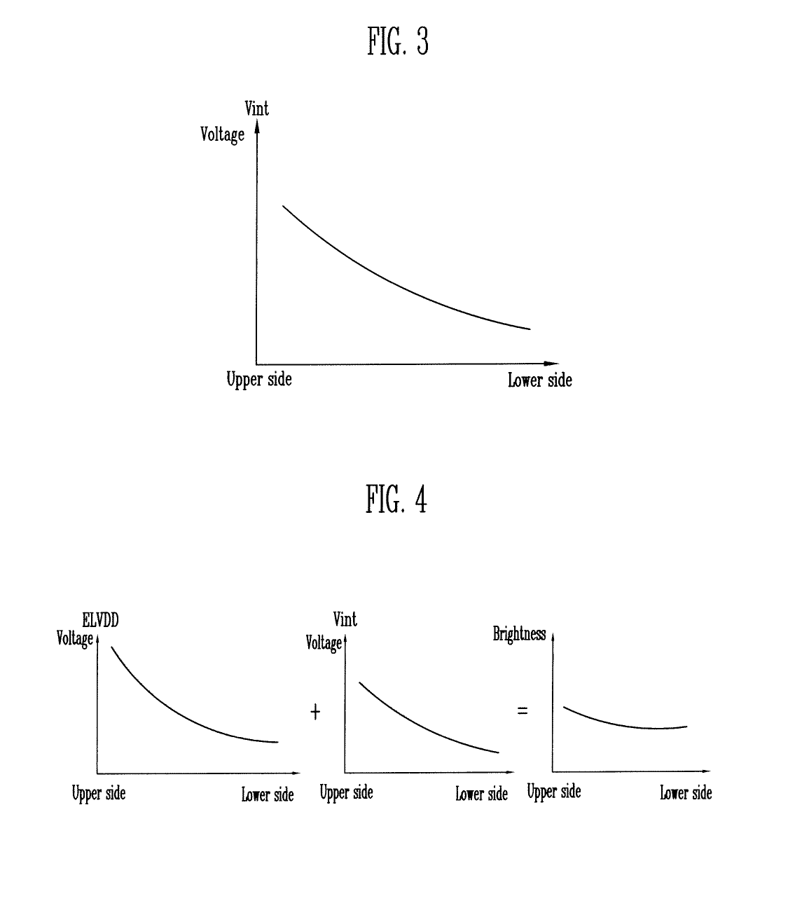

In more detail, the brightness of the pixel 140 increases as the voltage value of the initializing power supply Vint is lowered. Therefore, as illustrated in FIG. 4, when the voltage value of the initializing power supply Vint is set to correspond to the voltage drop of the first power supply ELVDD, an image with uniform brightness may be displayed on the entire panel, which will be described later in more detail.

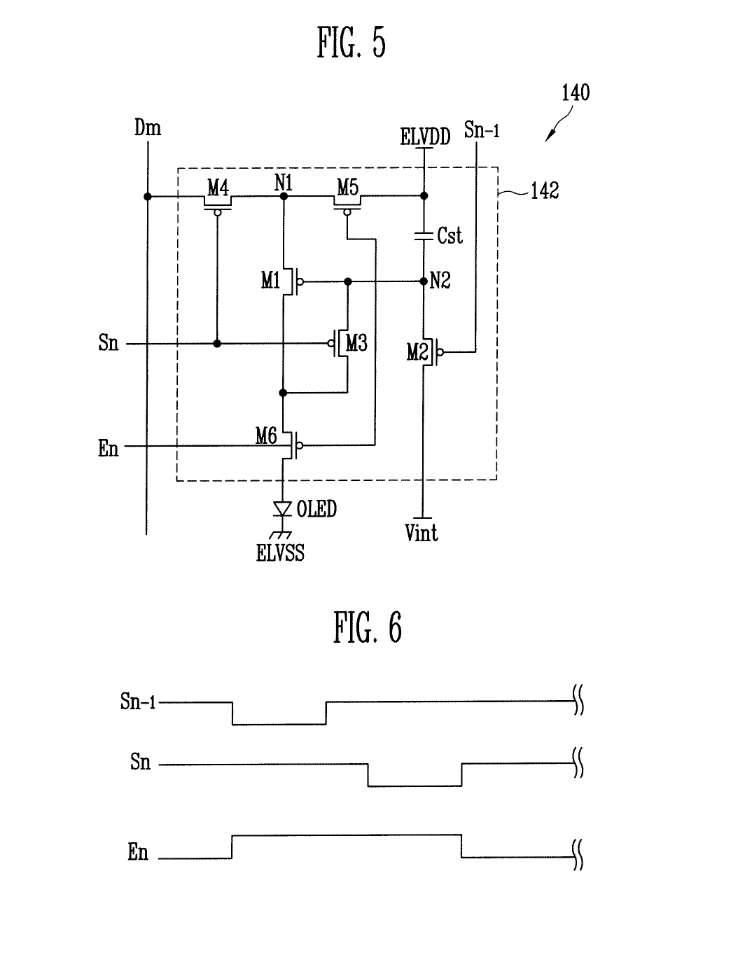

FIG. 5 is a circuit diagram illustrating a pixel of the panel of FIG. 1. In FIG. 5, as an example, the pixel coupled to the m-th data line Dm, the n-th scan line Sn, the (n−1)th scan line Sn−1, and the n-th emission control line En will be described.

Referring to FIG. 5, the pixel 140 according to an embodiment of the present invention includes an organic light emitting diode (OLED) and a pixel circuit 142 coupled to the data line Dm, the scan lines Sn−1 and Sn, and the emission control line En to control the amount of current supplied to the OLED.

The anode electrode of the OLED is coupled to the pixel circuit 142, and the cathode electrode of the OLED is coupled to the second power supply ELVSS. Here, the second power supply ELVSS is set to have a lower voltage than that of the first power supply ELVDD. The OLED generates light with brightness (e.g., predetermined brightness) corresponding to the amount of current supplied from the pixel circuit 142.

The pixel circuit 142 controls the amount of current supplied to the OLED to correspond to the data signal supplied to the data line Dm when a scan signal is supplied to the scan line Sn. In FIG. 5, the pixel circuit 142 includes first to sixth transistors M1 to M6 and a storage capacitor Cst.

The first electrode of the fourth transistor M4 is coupled to the data line Dm, and the second electrode of the fourth transistor M4 is coupled to a first node N1. The gate electrode of the fourth transistor M4 is coupled to the n-th scan line Sn. The fourth transistor M4 is turned on when a scan signal is supplied to the n-th scan line Sn to supply the data signal supplied to the data line Dm to the first node N1.

The first electrode of the first transistor M1 is coupled to the first node N1, and the second electrode of the first transistor M1 is coupled to the first electrode of the sixth transistor M6. The gate electrode of the first transistor M1 is coupled to a second node N2. The first transistor M1 supplies the current corresponding to the voltage charged in the storage capacitor Cst to the OLED.

The first electrode of the third transistor M3 is coupled to the second electrode of the second transistor M2, and the second electrode of the third transistor M3 is coupled to the second node N2. The gate electrode of the third transistor M3 is coupled to the n-th scan line Sn. The third transistor M3 is turned on when the scan signal is supplied to the n-th scan line Sn to couple the first transistor M1 in the form of a diode (e.g., diode-connected).

The second transistor M2 is coupled between the second node N2 and the initializing power supply Vint. The gate electrode of the second transistor M2 is coupled to the (n−1)th scan line Sn−1. The second transistor M2 is turned on when a scan signal is supplied to the (n−1)th scan line Sn−1 to supply the initializing power supply Vint to the second node N2. In one embodiment, the initializing power supply Vint is set as a lower voltage than the data signal.

The first electrode of the fifth transistor M5 is coupled to the first power supply ELVDD, and the second electrode of the fifth transistor M5 is coupled to the first node N1. The gate electrode of the fifth transistor M5 is coupled to the emission control line En. The fifth transistor M5 is turned on when an emission control signal is supplied from the emission control line En to electrically couple the first power supply ELVDD and the first node N1 to each other.

The first electrode of the sixth transistor M6 is coupled to the second electrode of the first transistor M1, and the second electrode of the sixth transistor M6 is coupled to the anode electrode of the OLED. The gate electrode of the sixth transistor M6 is coupled to the emission control line En. The sixth transistor M6 is turned on when the emission control signal is not supplied to supply the current supplied from the first transistor M1 to the OLED.

FIG. 6 is a view illustrating driving waveforms supplied to the pixel illustrated in FIG. 5.

Referring to FIG. 6, a scan signal is supplied to the (n−1)th scan line Sn−1 so that the second transistor M2 is turned on. When the second transistor M2 is turned on, the voltage of the initializing power supply Vint is supplied to the second node N2.

Here, the voltage value of the initializing power supply Vint is set to correspond to the position of pixel 140 at the panel as illustrated in FIG. 3. For example, the pixel 140 positioned at the upper side of the panel receives the initializing power supply Vint of a higher voltage than the pixel 140 positioned at the lower side of the panel.

After the initializing power supply Vint is supplied to the second node N2, the scan signal is supplied to the n-th scan line Sn. When the scan signal is supplied to the n-th scan line Sn, the third transistor M3 and the fourth transistor M4 are turned on. When the fourth transistor M4 is turned on, the data signal supplied to the data line Dm is supplied to the first node N1. At this time, since the second node N2 has been initialized to the voltage of the initializing power supply Vint, the first transistor M1 is turned on. Then, the data signal supplied to the first node N1 is supplied to the second node N2 via the first transistor M1 that is coupled in the form of a diode. The voltage of the second node N2 is increased to the voltage obtained by subtracting the threshold voltage of the first transistor M1 from the voltage of the data signal.

On the other hand, when it is assumed that the same data signal is supplied to all of the pixels 140, the amount of increase in the voltage of the second node N2 is determined by the voltage of the initializing voltage Vint. For example, when the voltage of the data signal is 1V, in the pixel that receives the initializing power supply Vint of −1V, the voltage of the second node N2 is increased from −1V to 1V. In the pixel that receives the initializing power supply Vint of −2V, the voltage of the second node N2 is increased from −2V to 1V.

Here, since a period in which the voltage of the second node N2 is increased (i.e., a period in which the scan signal is supplied) is limited, the voltage of the second node N2 of the pixel that receives the initializing power supply Vint of −1V is set to be higher than that of the second node N2 of the pixel that receives the initializing power supply Vint of −2V. That is, the pixel that receives the higher voltage of the initializing power supply Vint is set to having lower brightness than the pixel that receives the lower initializing power supply Vint.

Therefore, as illustrated in FIG. 3, when the brightness is reduced from the upper side of the panel toward the lower side of the panel, the brightness of the panel is increased from the upper side of the panel toward the lower side of the panel. In this case, as illustrated in FIG. 4, an image with substantial uniform brightness may be displayed on the panel to correspond to the voltage drop of the first power supply ELVDD and the voltage value of the initializing power supply Vint.

The voltage applied to the second node N2 is stored in the storage capacitor Cst. After a set or predetermined voltage is charged in the storage capacitor Cst, supply of the emission control signal to the emission control line En is stopped so that the fifth transistor M5 and the sixth transistor M6 are turned on. When the fifth transistor M5 and the sixth transistor M6 are turned on, a current path from the first power supply ELVDD to the OLED is formed. In this case, the first transistor M1 controls the amount of current that flows from the first power supply ELVDD to the OLED to correspond to the voltage charged in the storage capacitor Cst.

In the above embodiment, the pixel 140 is illustrated to include six transistors and one capacitor. However, the present invention is not limited to the above. In several embodiments, the present invention may be applied to pixels of various types in each of which the driving transistor M1 is coupled in the form of a diode to compensate for the threshold voltage of the driving transistor M1. When the driving transistor M1 is coupled in the form of a diode, the voltage of the gate electrode of the driving transistor M1 is initialized using the initializing power supply Vint.

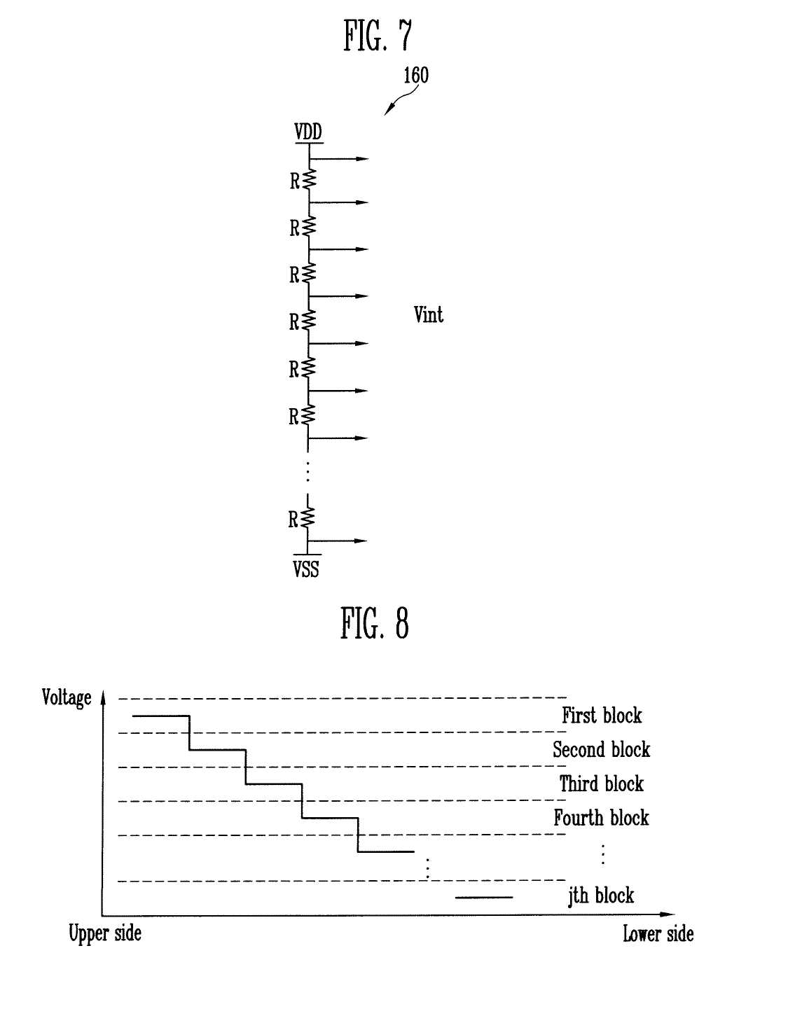

FIG. 7 is a view illustrating an initializing power supply generator according to an embodiment of the present invention.

Referring to FIG. 7, an initializing power supply generator 160 according to the embodiment of the present invention includes a plurality of resistors R serially coupled between a third power supply VDD and a fourth power supply VSS lower in voltage than the third power supply VDD. The resistors R divide the voltage between the third power supply VDD and the fourth power supply VSS to generate a plurality of initializing power supplies Vint. The plurality of initializing power supplies Vint are supplied to the pixels 140 to correspond to the positions of the pixels 140 at the panel as illustrated in FIG. 3.

On the other hand, in FIG. 3, it is illustrated that the voltage of the initializing power supply Vint varies according to the position of the panel (e.g., a horizontal line). However, the present invention is not limited to the above. For example, as illustrated in FIG. 8, the panel is divided into j (j is a natural number of no less than 2) blocks between one side (e.g., the upper side) and the other side (e.g., the lower side), and different initializing power supplies Vint may be supplied to the blocks, respectively. That is, the voltage of the initializing power supply Vint is set to be reduced from one side block of the panel toward the lower side block of the panel, and the initializing power supplies Vint of the same voltage are supplied to the pixels 140 positioned in the same block. In this case, the number of voltage dividing resistors R included in the initializing power supply generator 160 may be minimized or reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a panel comprising pixels, the pixels comprising driving transistors, the gate electrodes of the driving transistors being configured to be initialized by voltages supplied from an initializing power supply; and
an initializing power supply generator for supplying the initializing power supply,
wherein the initializing power supply generator is configured to set a voltage value of the initializing power supply to vary to correspond to a position of the panel.

2. The organic light emitting display as claimed in claim 1, further comprising a first power supply input to one side of the panel in order to supply current to the pixels.

3. The organic light emitting display as claimed in claim 2, wherein the initializing power supply generator is configured to generate the initializing power supply so that the voltage value of the initializing power supply is reduced from the one side of the panel toward another side of the panel.

4. The organic light emitting display as claimed in claim 1,
wherein the panel comprises a plurality of blocks between one side to another side of the panel, and
wherein the initializing power supply having the same voltage value is supplied to pixels positioned at the same block.

5. The organic light emitting display as claimed in claim 1, wherein the initializing power supply generator comprises a plurality of resistors positioned between a third power supply and a fourth power supply lower in voltage than the third power supply.

6. The organic light emitting display as claimed in claim 5, wherein voltages divided by the resistors are set as voltage values of the initializing power supply.

7. The organic light emitting display as claimed in claim 1, wherein each of the pixels comprises:
an organic light emitting diode (OLED) having a cathode electrode coupled to a second power supply;
a corresponding one of the driving transistors for controlling an amount of current supplied from the first power supply to the second power supply via the OLED; and
a second transistor coupled between a gate electrode of the driving transistor and the initializing power supply generator.

8. The organic light emitting display as claimed in claim 7, wherein each of the pixels further comprises a third transistor for coupling the driving transistor in a form of a diode.

9. A method of driving an organic light emitting display comprising pixels in which voltages of gate electrodes of driving transistors are initialized using initializing power supplies, the method comprising inputting a first power supply to one side of a panel comprising the pixels in order to supply current to the pixels,
wherein a voltage value of the initializing power supply is set to vary between one side of the panel and another side that faces the one side.

10. The method as claimed in claim 9, wherein the voltage value of the initializing power supply is set to be reduced from the one side of the panel toward the another side of the panel.

11. The method as claimed in claim 10,
wherein the panel is divided into a plurality of blocks between the one side and the another side, and
wherein pixels included in the same block receive the initializing power supplies having the same voltage value.
